(19) United States
(12) Patent Application Publication
(10) Pub. No.: US 2006/0107963 A1
(43) Pub. Date: May 25, 2006

(54) Flexible prosthodontic device

(76) Inventors: Robert L. Ibsen, Santa Maria, CA (US); Eckart Mathias, Goleta, CA (US)

Correspondence Address: CROWELL & MORING LLP;INTELLECTUAL PROPERTY GROUP, P.O. BOX 14300, WASHINGTON, DC, 20044-4300, US

(21) Appl. No.: 10/992,076

(22) Filed: Nov. 19, 2004

(51) Int. Cl. A61C 5/14

(52) U.S. Cl. 128/861

(57) ABSTRACT

A removable prosthodontic device for treating or diagnosing bruxism is disclosed. The present invention also provides a method for making a removable prosthodontic device. The present invention further provides a prosthodontic device for administering pharmacologic, tooth whitening and breath freshening compounds.

### FIELD OF THE INVENTION

The present invention relates to flexible prosthodontic devices. More particularly, the present invention is directed to prosthodontic devices for use in methods of diagnosing bruxism and as a guard to prevent the damage of teeth due to teeth grinding while asleep.

### BACKGROUND OF THE INVENTION

People who have otherwise healthy teeth and gums can clench so often and so hard that over time their teeth become sensitive. They experience jaw pain, tense muscles, and headaches along with excessive wear on their teeth. Forceful biting when not eating may cause the jaw to move out of proper balance. Bruxism is the technical term for this type of grinding and clenching that abrades teeth and cause facial pain. People who grind and clench, called bruxers, unintentionally bite down too hard at inappropriate times, such as in their sleep. In addition to grinding teeth, bruxers also may bite their fingernails, pencils and chew the inside of their cheek. People are not typically diagnosed with bruxism until there is noticeable damage to their teeth. A significant number of people suffer from bruxism, which, when diagnosed, can easily be treated by a dentist.

When a person has bruxism, the tips of the teeth often have a flattened appearance. Teeth can be worn down to the point that the enamel is rubbed off, exposing the inside of the tooth which is called dentin. When exposed, dentin may become sensitive. Bruxers may experience pain in their temporomandibular joint (TMJ), the jaw, which may manifest itself as popping and clicking. Women have a higher prevalence of bruxism possibly because they are more likely to experience tissue alterations in the jaw resulting from clenching and grinding. Tongue indentations are another sign of bruxism.

Bruxism has no specific cause, but is believed to be a combination of many factors, including, but not limited to, emotional stress, aggressive, controlling or precise personalities, and malocclusion (teeth that are not aligned properly). Further, children whose parents brux tend to be more likely to develop this habit than children whose parents do not brux. During regular dental visits a dentist should automatically check for physical signs of bruxism. If the dentist or patient notices signs of bruxism, the condition may be observed over several visits to be sure of the problem before recommending and starting therapy.

If undetected, bruxism can develop into a serious medical problem that can result is permanent damage to a person's teeth and jaws. During the process of chewing food, a force of about 175 pounds per square inch (psi) is delivered to the teeth. When an individual grinds his or her teeth at night there's no food to absorb the impact, so the force on the teeth can increase to 300 psi or more. Such force is enough to cause permanent damage to the teeth, including cracked and chipped enamel, hairline fractures, and even wearing down of the teeth to the gumline. The enamel may become so worn that the dentin is exposed. If bruxism is not treated, it can lead to gum damage, loss of both natural teeth and restorations, and other more complicated jaw-related disorders (such as temporomandibular joint disorders). Over time, teeth may become sensitive due to exposed dentin, and the jaws may even move out of proper balance. Grinding of teeth can also cause a wide variety of other symptoms including soreness and fatigue in the jaw and facial muscles and earaches or headaches.

There is no known cure for bruxism. There are, however, several treatments for bruxism including stress reduction, behavioral therapies, and intra-oral appliances. The most commonly used intra-oral appliances used in the treatment of bruxism are removable prosthodontic devices commonly known as nightguards or mouthguards.

Commercially available home-moldable nightguards are commonly made by the user impressing the upper or lower row of teeth into a U-shaped heat-softened plastic block. The fit is thus established in a rigid piece of plastic, which is significantly harder and bulkier that the guard of the present invention. Because the plastic is not moldable at room temperature, it often requires multiple fitting attempts, each time requiring the use of hot water to re-soften the plastic. These rigid nightguards are uncomfortable, and, depending on the material of construction, can be very screechy or noisy, precluding a good night's sleep. Thus there is a need for a comfortable, easily to make and use prosthodontic device for treating and/or diagnosing bruxism.

### SUMMARY OF THE INVENTION

The present invention is directed to a removable prosthodontic device for treating or diagnosing bruxism. One embodiment of the present invention further provides a method for making a removable prosthodontic device. Another embodiment of the present invention also contemplates a prosthodontic device for administering pharmacologic, tooth whitening and breath freshening compounds. Another embodiment of the present invention is the concept of using a tough material that resists the frictions of bruxism only at the location where the teeth will be making contact with each other. The remainder of the device is made of a soft and conforming material to give a comfortable feel for the user. Further, the present invention includes methods of making and using prosthodontic devices.

### BRIEF DESCRIPTION OF THE FIGURES

FIG. 1 illustrates a prosthodontic device in accordance with the instant invention.

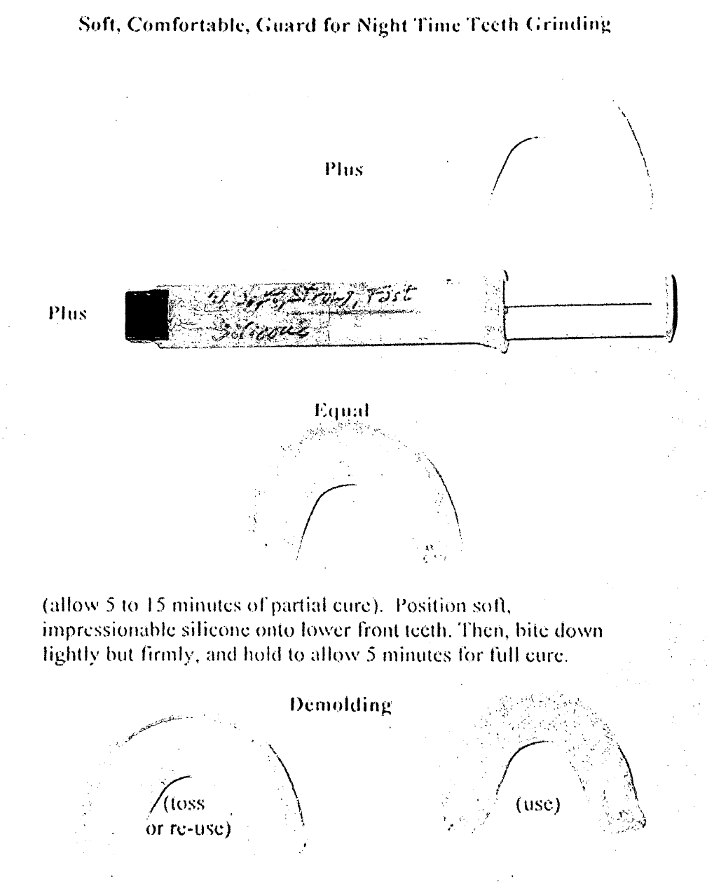

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other compositions and methods, and that any such variation would be within such modifications that do not part from the scope of the present invention. Before explaining the disclosed embodiments of the present invention in detail, it is to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

The present invention is directed to a removable prosthodontic device. This device is a mouth guard for preventing teeth damage due to involuntary teeth grinding during sleep. The present invention provides a wear resistant surface material between the upper and lower row of teeth. This wear resistant material is held in place by getting it imbedded into a soft, curable elastomeric polymer, which, while still soft, also molds itself substantially around the individual teeth of the user. This elastomeric fitting is achieved while the teeth are kept impressed in the still-curing polymer until the cure is complete.

The wear resistant surface is a thin, flat piece of material, which is cut in to a U-shaped object, simulating the arch of the row of teeth of the user. Unless required otherwise, the arch used will be that of the lower row of teeth.

The above flat, U-shaped, piece of material is laid in to the trough of a dental tray (preferably, a disposable soft tray, such as those made of a foamed plastic, EVA, PVC or equivalent), and then covered with a curable liquid polymer mixture, such as a two-component silicone. The trough of the tray is nearly completely filled with this polymer, and the U-shaped insert becomes completely submerged in the liquid. The reactive polymer may be dispensed from a dual syringe or cartridge, provided with a stationary mixer tip. This liquid polymer is chosen to cure within several minutes during which time it looses its ability to flow out of the tray. At this stage of cure, i.e., prior to complete cure, the filled tray is flipped over and laid onto the lower row of teeth. The user then bites down on to the device and holds the bite until the reactive polymer completes its cure, thus locking-in the teeth impression. After carefully removing the device, the imbedded wear-resistant insert, together with the polymer elastomer, is peeled out of the tray. The device is now ready for use by reinserting it into the mouth. The tray can either be reused or disposed of. After overnight use of this nightguard, the user can either dispose of the device, or reuse it until worn out, by storing it submerged in a small amount of anti-bacterial mouthwash.

The device of the present invention is small and soft, and comfortable to wear, hence, allowing a restful sleep. Its elastomeric compliance provides easy adaptation to minor imperfections that may have resulted while making it. This device would usually be made just prior to bedtime therefore, it would always fit well and not be influenced by teeth shifting.

One embodiment of the instant invention may be made as follows:

1. Place the thin, flat, U-shaped insert into a foam-tray.

2. Dispense a liquid, curable silicone composition in to the trough, filling it almost to the rim, and covering the insert completely.

3. Allow time for a partial, tack-free cure. Time will be dictated by the choice of curable composition.

4. Position tray (with partially cured polymer resin) onto the front arch of the teeth.

5. Bite down slowly, completely and firmly into the deformable still-curing resin, and hold the bite.

6. Allow the resin to completely cure. Time will be dictated by the choice of the curable composition.

7. Lift out the complete assembly, i.e., the tray and the insert/silicone combination. This is easily achieved by using the tip of the index finger, and applying a slight pressure to the device at the edge of the device at the gum line.

8. Demold/peel-off the soft device from the foam-tray.

9. Discard the tray or save for re-use.

One of skill in the art would recognize that any of a number of durable materials would provide the necessary characteristics of the U-shaped insert. As such, the present invention is not limited to any particular materials or compositions herein described. A preferred material of construction of the insert is polypropylene non-woven “filter cloth”. Matting made of other fibrous materials such as leather, strong synthetic fibers and tough, non-fibrous materials made of natural and/or synthetic polymers may also be used for the U-shaped insert.

A preferred material for construction of the tray is a foamed polymer material, e.g., polypropylene, polyethylene or polystyrene. Reasonably soft non-foamed polymeric materials, e.g., ethylene-vinyl acetate copolymer (EVA), low molecular weight polyethylene (PE) and polypropylene (PP), polyurethane (PU), silicone, and plasticized polyvinyl chloride (PVC) may also be used as a material for constructing the tray.

A preferred curable composition for forming the bulk of the device is a 2-component silicone, dispensed from a dual syringe/cartridge at a 1 to 1 ration of “part A” and “part B”. Other compositions that could be used include curable liquids which, when fully cured, are still soft to the touch, for example, 1 or 2 part solventless, curable compositions.

### EXAMPLE 1

Place a U-shaped 1-mm thick polypropylene (PP) non-woven insert into a flat-bottomed trough of a U-shaped foam tray. Set up tray with insert in such a manner as to have the lowest edge of the two open ends of the tray be level and about 1 mm below the edge of the front wall of the foam tray. This positioning is easily achieved by placing the foam tray between two edges of two ¼ inch thick plates which are set about 25 mm apart. The tray is rested between these plates. Insure that the insert is laying flat down in the trough of the tray. Dispense into the tray enough liquid silicone rubber material so as to have the liquid cover the insert completely and to about 1 mm below the front edge of the tray.

Allow the silicone to cure partially, approximately 15 minutes. Without delay, flip the tray with its contents over and place it carefully into position with the teeth barely touching the silicone. Once the position is deemed satisfactory, bite straight down onto the device to impress the lower teeth into the still-soft and curing silicone. Hold the bite closed for 5 minutes to allow the silicone to cure completely.

To de-mold the device, open the bite, and with the tip of the index finger press lightly under the front edge of the device, running the finger tip side to side at the gum line with a slight upward pressure. The device will come out very easily.

Rinse the foam tray containing the device in warm water and peel the device out of the tray. The device is now ready to use. Dispose of the tray or, if not damaged, keep it for further use.

### EXAMPLE 2

Place a U-shaped leather insert into a flat-bottomed trough of a U-shaped foam tray. Set up tray with insert in such a manner as to have the lowest edge of the two open ends of the tray be level and about 1 mm below the edge of the front wall of the foam tray. This positioning is easily achieved by placing the foam tray between two edges of two ¼ inch thick plates which are set about 25 mm apart. The tray is rested between these plates. Insure that the insert is laying flat down in the trough of the tray. Dispense into the tray enough liquid silicone rubber material so as to have the liquid cover the insert completely and to about 1 mm below the front edge of the tray.

Allow the silicone to cure partially, approximately 15 minutes. Without delay, flip the tray with its contents over and place it carefully into position with the teeth barely touching the silicone. Once the position is deemed satisfactory, bite straight down onto the device to impress the lower teeth into the still-soft and curing silicone. Hold the bite closed for 5 minutes to allow the silicone to cure completely.

To de-mold the device, open the bite, and with the tip of the index finger press lightly under the front edge of the device, running the finger tip side to side at the gum line with a slight upward pressure. The device will come out very easily.

Rinse the foam tray containing the device in warm water and peel the device out of the tray. The device is now ready to use. Dispose of the tray or, if not damaged, keep it for further use.

### EXAMPLE 3

Place a U-shaped polyethylene/vinyl acetate (EVA) insert into a flat-bottomed trough of a U-shaped foam tray. Set up tray with insert in such a manner as to have the lowest edge of the two open ends of the tray be level and about 1 mm below the edge of the front wall of the foam tray. This positioning is easily achieved by placing the foam tray between two edges of two ¼ inch thick plates which are set about 25 mm apart. The tray is rested between these plates. Insure that the insert is laying flat down in the trough of the tray. Dispense into the tray enough liquid silicone rubber material so as to have the liquid cover the insert completely and to about 1 mm below the front edge of the tray.

Allow the silicone to cure partially, approximately 15 minutes. Without delay, flip the tray with its contents over and place it carefully into position with the teeth barely touching the silicone. Once the position is deemed satisfactory, bite straight down onto the device to impress the lower teeth into the still-soft and curing silicone. Hold the bite closed for 5 minutes to allow the silicone to cure completely.

To de-mold the device, open the bite, and with the tip of the index finger press lightly under the front edge of the device, running the finger tip side to side at the gum line with a slight upward pressure. The device will come out very easily.

Rinse the foam tray containing the device in warm water and peel the device out of the tray. The device is now ready to use. Dispose of the tray or, if not damaged, keep it for further use.

### EXAMPLE 4

Place a U-shaped 1-mm thick polypropylene (PP) non-woven insert into a flat-bottomed trough of a U-shaped polyethylene/vinyl acetate (EVA) tray. Set up tray with insert in such a manner as to have the lowest edge of the two open ends of the tray be level and about 1 mm below the edge of the front wall of the foam tray. This positioning is easily achieved by placing the foam tray between two edges of two ¼ inch thick plates which are set about 25 mm apart. The tray is rested between these plates. Insure that the insert is laying flat down in the trough of the tray. Dispense into the tray enough liquid silicone rubber material so as to have the liquid cover the insert completely and to about 1 mm below the front edge of the tray.

Allow the silicone to cure partially, approximately 15 minutes. Without delay, flip the tray with its contents over and place it carefully into position with the teeth barely touching the silicone. Once the position is deemed satisfactory, bite straight down onto the device to impress the lower teeth into the still-soft and curing silicone. Hold the bite closed for 5 minutes to allow the silicone to cure completely.

To de-mold the device, open the bite, and with the tip of the index finger press lightly under the front edge of the device, running the finger tip side to side at the same time with a slight upward pressure. The device will come out very easily. Rinse the foam tray containing the device in warm water and peel the device out of the tray. The device is now ready to use. Dispose of the tray or, if not damaged, keep it for further use.

### EXAMPLE 5

The device may be made in-house by the consumer whenever he or she feels that its use would alleviate the effects of grinding teeth. It may also be prescribed by a dental care professional for temporary use to help diagnose or confirm bruxism per se, and establish its severity. The instant device can be used to locate the most severe grinding areas, and alleviate the pain associated with TMJ, and the headaches arising from bruxism.

While the main purpose of the device is as a physical tool to prevent damage caused by bruxism and/or to diagnose the existence of bruxism, the device may also be used to deliver certain ingredients or agents to the teeth and gums. Permeable inserts and curable resins containing active ingredients and agents which are therapeutic in nature may be used in making the devices of the instant invention. Therefore, the instant invention contemplates methods of using the disclosed device to deliver active ingredients, including, but not limited to, therapeutic agents such as fluoride, anti-microbials, anti-fungals, topical medications, coloring agents, and breath freshening agents to the teeth and gums.

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A prosthodontic device comprising a durable insert and a curable composition.

2. The prosthodontic device of claim 1, wherein the insert is comprised of polypropylene.

3. The prosthodontic device of claim 1, wherein the insert is polypropylene, non-woven filter cloth.

4. The prosthodontic device of claim 1, wherein the insert is U-shaped.

5. The prosthodontic device of claim 1, wherein the curable composition is silicone.

6. The prosthodontic device of claim 1, further comprising a pharmacologic, tooth whitening or breath freshening composition.

7. A method of making a prosthodontic device comprising the steps of:
(a) placing a thin, flat, durable insert into a tray;
(b) dispense a liquid, curable composition into the tray, covering said insert completely;
(c) allow time said curable composition to partially cure;
(d) insert a patient's teeth into said partially cured composition;
(e) allow the resin to completely cure thereby forming a prosthodontic device;
(f) removing said prosthodontic device from said tray.

8. The method of claim 7, wherein the insert is comprised of polypropylene.

9. The method of claim 7, wherein the insert is polypropylene, non-woven filter cloth.

10. The method of claim 7, wherein the curable composition is silicone.

11. The method of claim 7, further comprising the step of adding a pharmacological, tooth whitening, coloring agent or breath freshening composition to the curable composition.

12. A method of treating bruxism comprising:
(a) placing a thin, flat, durable insert into a tray;
(b) dispense a liquid, curable composition into the tray, covering said insert completely;
(c) allow time said curable composition to partially cure;
(d) insert a patient's teeth into said partially cured composition;
(e) allow the resin to completely cure thereby forming a prosthodontic device;
(f) removing said prosthodontic device from the tray;
(g) placing said prosthodontic device over the teeth of said patient.

13. A method of diagnosing bruxism comprising:
(a) placing a thin, flat, durable insert into a tray;
(b) dispense a liquid, curable composition into the tray, covering said insert completely;
(c) allow time said curable composition to partially cure;
(d) insert a patient's teeth into said partially cured composition;
(e) allow the resin to completely cure thereby forming a prosthodontic device;
(f) removing said prosthodontic device from the tray;
(g) placing said prosthodontic device over the teeth of said patient;
(h) allow said patient to wear said prosthodontic device for a period of time;
(i) inspecting the prosthodontic device for evidence of bruxing.
